(19) United States
(12) Patent Application Publication
(10) Pub. No.: US 2008/0080093 A1
(43) Pub. Date: Apr. 3, 2008

(54) Magnetic recording medium and magnetic recording device

(75) Inventors: Ryosaku Inamura, Kawasaki (JP); Isatake Kaitsu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/898,959

(22) Filed: Sep. 18, 2007

(30) Foreign Application Priority Data
Sep. 29, 2006 (JP) 2006-268882
Oct. 26, 2006 (JP) 2006-291427

(51) Int. Cl. G11B 5/127

(52) U.S. Cl. 360/125.73

(57) ABSTRACT

A magnetic recording medium according to the present invention includes a nonmagnetic base material, a soft magnetic under layer, an interlayer, a recording layer and a protective layer, which are stacked over the base material. The soft magnetic under layer is formed of a lower soft magnetic layer, a magnetic domain control layer (or a nonmagnetic layer) and an upper soft magnetic layer. The lower and upper soft magnetic layers are each made of a material amorphized by adding at least one of zirconium (Zr) and tantalum (Ta) to an iron-cobalt (Fe—Co) alloy which is composed to form a body-centered cubic (bcc) structure.

### CROSS-REFERENCE TO RELATED APPLICATIONS

This application is based on and claims priority of Japanese Patent Applications No. 2006-291427 filed on Oct. 26, 2006, and No. 2006-268882 filed on Sep. 29, 2006, the entire contents of which are incorporated herein by reference.

### BACKGROUND OF THE INVENTION

1. Field of the Invention

The present invention relates to a magnetic recording medium which magnetically records information and a magnetic recording device using the magnetic recording medium, and more particularly to a magnetic recording medium of a perpendicular magnetic recording type and a magnetic recording device using the magnetic recording medium.

2. Description of the Prior Art

Computers handle an increasingly larger amount of information year by year, which requires that a recording device for recording information achieve a still higher density. A magnetic recording device (e.g., a so-called hard disk drive unit) which magnetically records information on a magnetic disk (i.e., a recording medium) has been heretofore used as a recording device for a computer. Recently, this type of magnetic recording device (e.g., the hard disk drive unit) has come into use for not only a computer but also for a video recording equipment such as a hard disk video recorder, a portable music player, and the like.

A recording medium of an in-plane magnetic recording type (hereinafter referred to simply as an “in-plane magnetic recording medium”), has hitherto been generally adopted as the recording medium for use in the magnetic recording device. In the recording layer of an in-plane magnetic recording medium, the direction of magnetization is in an in-plane direction. In order for the in-plane magnetic recording medium to achieve a higher recording density, it is necessary to make the recording layer thinner and also make magnetic particles in the recording layer finer to thereby reduce interaction among the magnetic particles. Finer magnetic particles in the recording layer, however, cause a phenomenon in which information is destroyed by heat. This phenomenon is called “thermal fluctuation,” which is a factor responsible for a hindrance to an increase in the recording density of the magnetic recording medium. The likelihood of the thermal fluctuation occurring is related to the volume of the magnetic particles. Specifically, the thermal fluctuation is more likely to occur as the volume of the magnetic particles becomes smaller.

A recording medium of a perpendicular magnetic recording type (hereinafter referred to simply as a “perpendicular magnetic recording medium”), has recently been in practical use. In the recording layer of a perpendicular magnetic recording medium, the direction of magnetization is perpendicular to the in-plane direction. Because of using magnetic particles of a configuration extending in the direction of the thickness of the recording layer, the perpendicular magnetic recording medium holds a smaller magnetic domain, on the recording layer, thus making it possible to achieve a still higher recording density, than the in-plane magnetic recording medium. Moreover, the perpendicular magnetic recording medium can suppress the occurrence of the thermal fluctuation, because of being capable of increasing its recording density without making the magnetic particles excessively finer.

The perpendicular magnetic recording medium generally has a laminated structure, which is formed over a substrate and is formed of a soft magnetic under layer, an interlayer and a recording layer, which are stacked one over another. The soft magnetic under layer is provided to suppress the widening of a magnetic field produced by a magnetic head and thereby magnetize the recording layer with efficiency. The interlayer is provided for the purpose of magnetically isolating the recording layer and the soft magnetic under layer from each other and also of controlling the orientation of the magnetic particles that form the recording layer.

A recording layer of a granular structure (hereinafter referred to simply as a “granular recording layer”) is generally used for the perpendicular magnetic recording medium. The granular recording layer is formed of columnar magnetic particles whose longitudinal direction coincides with the direction of the thickness of the recording layer, and a nonmagnetic material (e.g., oxide or nitride) which provides magnetic isolation between the magnetic particles. The magnetic particles of the granular recording layer are made of, for example, CoCrPt (cobalt-chromium-platinum), and the nonmagnetic material is made of, for example, silicon oxide (SiO₂).

Japanese Patent Application Laid-Open Publication No. 2004-30851 discloses a perpendicular magnetic recording medium including a soft magnetic layer, which soft magnetic layer is formed of magnetic particles made of an alloy of iron (Fe) and cobalt (Co), and a nonmagnetic intergranular substance containing at least one kind of element belonging to a group consisting of boron (B), carbon (C), nitrogen (N), silicon (Si), phosphorus (P), lead (Pb), tin (Sn) and germanium (Ge).

Japanese Patent Application Laid-Open Publication No. 2005-302238 discloses a perpendicular magnetic recording medium including a soft magnetic under layer, which soft magnetic under layer is formed of first and second amorphous soft magnetic layers, and a nonmagnetic layer sandwiched between the amorphous soft magnetic layers. In this disclosure, the amorphous soft magnetic layers are each made of, for example, an Fe—Co—B alloy having an Fe content of 52 at %, a Co content of 31 at %, and a B content of 12 at %.

Japanese Patent Application Laid-Open Publication No. 2002-25030 discloses a perpendicular magnetic recording medium including a soft magnetic soft magnetic under layer made of FeCoB, FeCoNi (iron-cobalt-nickel), or FeCo. Japanese Patent Application Laid-Open Publication No. 2005-196813 discloses a magnetic recording medium including a recording layer having a titanium-oxide content of 5 to 15 mol %.

It is necessary to enhance the coercivity (Hc) of the recording layer in order that the perpendicular magnetic recording medium may promote a further increase in the recording density and also improve the reliability of the writing and reading of information. For the enhancement of the coercivity (Hc) of the recording layer, it is important to optimize the thicknesses of the recording layer and the interlayer or materials therefore.

In the case of a CoCrPt-oxide-base granular recording layer for general use in the perpendicular magnetic recording medium, it is known that the Cr or oxide content is reduced to enhance the coercivity. The reduced Cr or oxide content, however, leads to the problem of increasing noise. The film thicknesses of the interlayer and the recording layer may be increased to enhance the coercivity (Hc). The increased film thicknesses of the interlayer and the recording layer, however, makes the distance between the magnetic head and the soft magnetic under layer to grow so far as to degrade signal quality.

As mentioned above, the thicknesses of the recording layer and the interlayer or the materials therefore can be changed to enhance the coercivity of the recording layer, but such changes lead to the increase in noise or the degradation in the signal quality, thus causing the problem of reducing the reliability of the writing and reading of information.

### SUMMARY OF THE INVENTION

According to one aspect of the present invention, provided is a magnetic recording medium including: a nonmagnetic base material; a soft magnetic under layer formed over the nonmagnetic base material; an interlayer formed over the soft magnetic under layer; and a recording layer having perpendicular magnetic anisotropy formed over the interlayer. The soft magnetic under layer is made of a material amorphized by adding at least one kind of element of zirconium (Zr) and tantalum (Ta) to an iron-cobalt (Fe—Co) alloy which is composed to form a body-centered cubic structure.

### BRIEF DESCRIPTION OF THE DRAWINGS

FIG. 1 is a cross-sectional view showing a magnetic recording medium according to a first embodiment of the present invention.

FIGS. 2A to 2F are cross-sectional views illustrating a method of manufacturing the magnetic recording medium according to the first embodiment.

FIG. 3 is a cross-sectional view showing an example of a structure in which a single soft magnetic soft magnetic under layer is formed above an antiferromagnetic layer.

FIG. 4 is a schematic sectional view of assistance in explaining operation for writing information to the magnetic recording medium according to the first embodiment.

FIG. 5 is a table showing material compositions of test specimens of the first embodiment, which were used for coercivity measurements.

FIG. 6 is a plot showing a Slater-Pauling curve.

FIG. 7 is a graph showing the results of XRD (X-ray diffraction) measurements made on soft magnetic under layers.

FIG. 8 is a plot showing the results of examinations as to the read/write characteristics of test specimens.

FIG. 9 is a cross-sectional view showing a magnetic recording medium according to a second embodiment of the present invention.

FIG. 10 is a plot showing the relation between the titanium oxide content in a main recording layer and coercivity.

FIG. 11 is a table showing material compositions of test specimens of the second embodiment, which were used for coercivity and S/N ratio measurements.

FIG. 12 is a plan view showing a magnetic recording device according to an embodiment of the present invention.

### DESCRIPTION OF THE PREFERRED EMBODIMENT

The inventors have carried out various experimental researches in order to enhance the coercivity of a recording layer of a perpendicular magnetic recording medium. As a result, the inventors have made findings as given below: when a material amorphized by adding at least one kind of element of zirconium (Zr) and tantalum (Ta) to an iron-cobalt (Fe—Co) alloy having a body-centered cubic (bcc) structure is used as a magnetic material to form a soft magnetic under layer, a magnetic recording medium using this material can enhance the coercivity of the recording layer as compared to a conventional magnetic recording medium. The present invention has been made based on such experimental researches.

As the element to be added to the Fe—Co alloy, instead of Zr and Ta, at least one kind of the following elements may be used: niobium (Nb); silicon (Si); boron (B); titanium (Ti); tungsten (W); chromium (Cr) and carbon (C). Also with this structure, the magnetic recording medium can enhance the coercivity of the recording layer as compared to the conventional magnetic recording medium. Experiments by the inventors, however, have shown that the use of the Fe—Co alloy containing Zr or Ta added thereto achieves a higher degree of enhancement of the coercivity of the recording layer, as compared to the use of the Fe—Co alloy containing any of Nb, Si, B, Ti, W, Cr and C added thereto.

Preferably, the soft magnetic under layer has a structure as given below: the soft magnetic under layer is formed of the first and second soft magnetic layers made of the aforementioned amorphized material, and a nonmagnetic layer sandwiched between the soft magnetic layers, and the first soft magnetic layer is antiferromagnetically coupled to the second soft magnetic layer. Preferably, the thicknesses of the first and second soft magnetic layers each lie between 20 and 30 nm inclusive. Also, the Fe content in the amorphized material is preferably equal to or more than 30 at %.

Preferably, the interlayer formed over the soft magnetic under layer has a laminated structure, which is formed of a polycrystalline film having a face-centered cubic (fcc) structure, and a polycrystalline film formed over the polycrystalline film and having a hexagonal close-packed (hcp) structure. Preferably, the recording layer is formed of a first recording layer having a granular structure, and a second recording layer formed over the first recording layer and made of a Co based alloy. This structure is adapted as given below: the first recording layer is formed of magnetic particles made of a cobalt-chromium-platinum (Co—Cr—Pt) alloy and a nonmagnetic material made of titanium oxide, the Cr content in the Co—Cr—Pt alloy lies between 11 and 15 at % inclusive, the Pt content in the Co—Cr—Pt alloy lies between 11 and 21 at % inclusive, and the molar ratio between the Co—Cr—Pt alloy and the titanium oxide in the first recording layer lies between a ratio of 93 to 7 and a ratio of 91 to 9. This structure can increase an S/N (signal-to-noise) ratio and thus achieve the magnetic recording medium capable of still higher performance.

According to the present invention, the coercivity of the recording layer of the perpendicular magnetic recording medium can be enhanced, so that the recording layer can record information at still higher recording densities than hitherto. Moreover, the S/N ratio can be raised to thereby improve the reliability of writing and reading of the magnetic recording device.

The recording layer has the granular structure formed of the Co—Cr—Pt alloy and the titanium oxide, and the compositions thereof and the molar ratio therebetween are set within respective predetermined ranges. Using the recording layer of this structure enables a further reduction in noise originating from the magnetic recording medium and hence a further improvement in the reliability of the magnetic recording device.

Preferred embodiments of the present invention will be described below with reference to the accompanying drawings.

(Magnetic Recording Medium)

### (1) First Embodiment

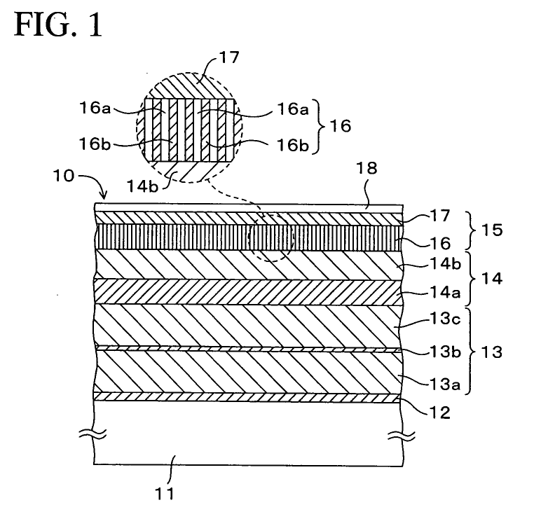

FIG. 1 is a cross-sectional view showing a magnetic recording medium according to a first embodiment of the present invention. A magnetic recording medium 10 according to the first embodiment includes a base material 11 in the shape of a disc of, for example, 2.5 inches in diameter, and a laminated structure formed over the base material 11. The laminated structure is formed of, in sequence, a seed layer 12, a soft magnetic under layer 13, an interlayer 14, a recording layer 15 and a protective layer 18, stacked one over another in a series of layers. The soft magnetic under layer 13 is formed of three layers as given below: a lower soft magnetic layer 13a, a magnetic domain control layer (or a nonmagnetic layer) 13b and an upper soft magnetic layer 13c. The interlayer 14 is formed of an orientation control layer 14a and a nonmagnetic layer 14b. The recording layer 15 is formed of a main recording layer (or a first recording layer) 16 and an auxiliary write layer (or a second recording layer) 17.

Further, the main recording layer 16 has a granular structure, which is formed of magnetic particles 16b, the easy magnetization axis of which are oriented perpendicularly to the surface of the magnetic recording medium 10, and a nonmagnetic material 16a which provides magnetic isolation between the magnetic particles 16b. The auxiliary write layer 17 is composed of a magnetic material made of a cobalt (Co) base alloy while the magnetic material has a nongranular structure.

In the magnetic recording medium 10 according to the first embodiment, the soft magnetic layers 13a and 13c are each made of a soft magnetic material amorphized by adding zirconium (Zr) and tantalum (Ta) to an iron-cobalt (Fe—Co) alloy of such composition as forms a body-centered cubic (bcc) structure.

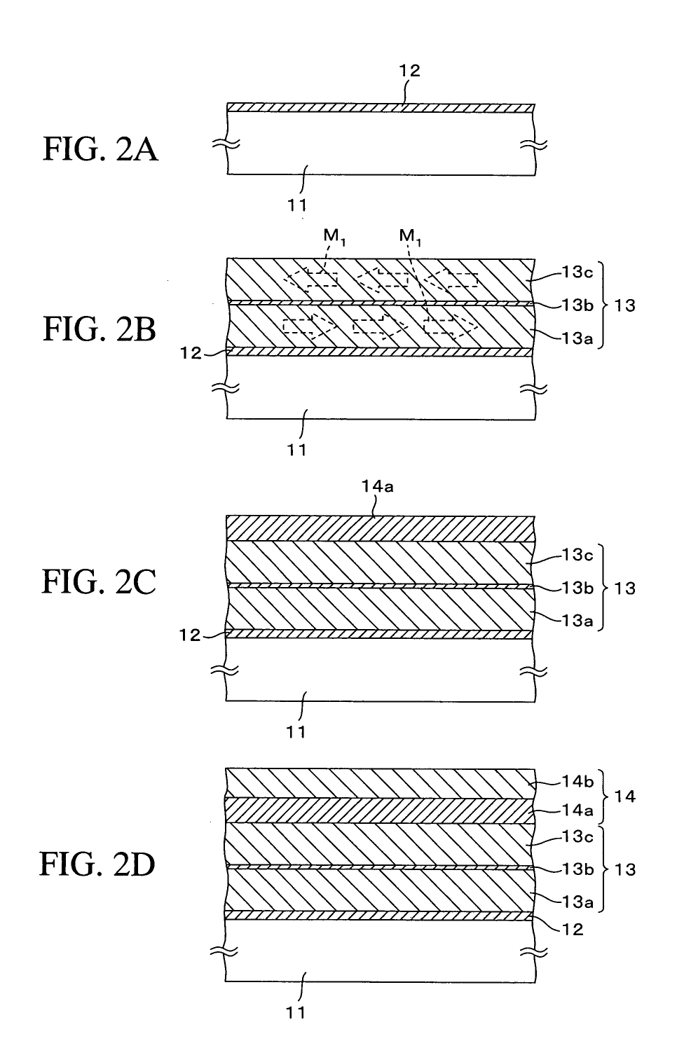

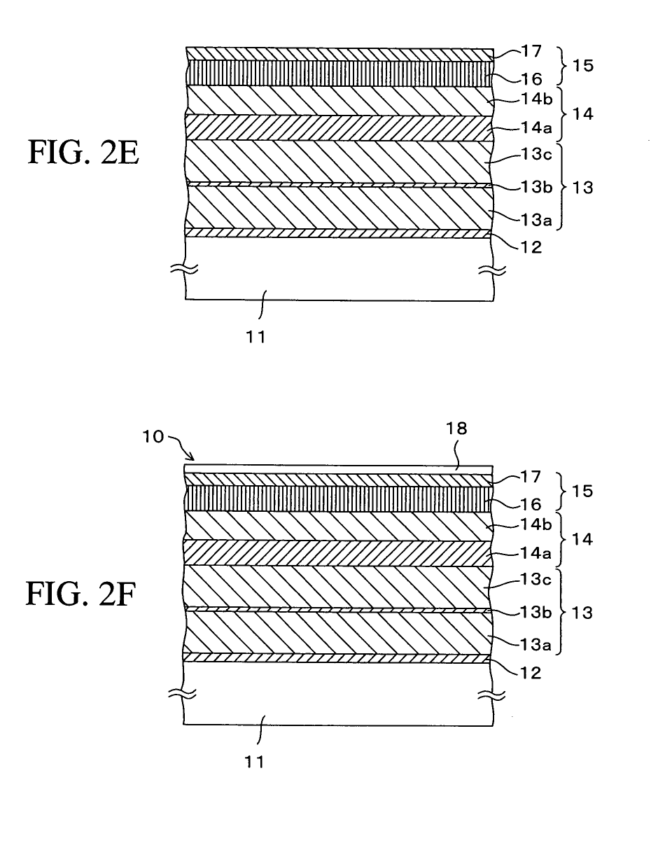

FIGS. 2A to 2F are cross-sectional views illustrating process steps, one after another, in a method of manufacturing the magnetic recording medium according to the first embodiment. Details of the magnetic recording medium 10 according to the first embodiment will be described with reference to FIGS. 2A to 2F.

First, as shown in FIG. 2A, the base material 11 is prepared for example by subjecting the surface of a glass substrate to chemical treatment to improve the stiffness thereof. Then, the seed layer 12 is formed over the base material 11 by depositing chromium (Cr) in a thickness of about 3 nm by sputtering method under the following conditions: a deposition pressure of about 0.3 to 0.8 Pa. Here, the growth rate of the seed layer 12 is not particularly limited. In the first embodiment, the growth rate of the seed layer 12 is set at 5 nm/sec. The seed layer 12 acts so as not to transfer the surface state of the base material 11 to the lower soft magnetic layer 13a to be formed at a next process step, and also functions as a bonding layer. The seed layer 12 may be omitted, provided that there is no problem with the crystallinity and bonding properties of the lower soft magnetic layer 13a.

In the first embodiment, the glass substrate is used as the base material 11. However, it should be noted that a material other than the glass substrate may be used for the base material 11. For example, a plastic substrate, a substrate made of a NiP-plated aluminum alloy, a silicon substrate or the like, besides the glass substrate previously mentioned, may be used as the base material 11 for a solid magnetic recording medium such as a hard disk. Likewise, a tape or sheet made of resin such as polyethylene terephthalate (PET), polyethylene naphthalate (PEN) or polyimide may be used as the base material 11 to manufacture a magnetic recording medium in tape or sheet form.

Next, as shown in FIG. 2B, the lower soft magnetic layer 13a is formed by forming a soft magnetic amorphous FeCoZrTa layer in a thickness of, for example, 30 nm over the seed layer 12 by sputtering method under the following conditions: a deposition pressure of 0.3 to 0.8 Pa and a growth rate of 5 nm/sec. In the first embodiment, the lower soft magnetic layer 13a is made of FeCoZrTa. The lower soft magnetic layer 13a can be made of an amorphous material obtained by adding to an iron-cobalt (Fe—Co) alloy which is composed to form a body-centered cubic (bcc) structure, at least one of the following elements: zirconium (Zr); tantalum (Ta); niobium (Nb); silicon (Si); boron (B); titanium (Ti); tungsten (W); chromium (Cr) and carbon (C). Preferably, the thickness of the lower soft magnetic layer 13a lies between 20 and 30 nm inclusive.

Then, the magnetic domain control layer (or the nonmagnetic layer) 13b is formed over the lower soft magnetic layer 13a by depositing ruthenium (Ru) in a thickness of, for example, 0.4 to 3 nm by sputtering method. The magnetic domain control layer 13b may be made of rhodium (Rh), iridium (Ir), copper (Cu), or the like.

Then, the upper soft magnetic layer 13c is formed by forming a soft magnetic amorphous FeCoZrTa layer in a thickness of, for example, 30 nm over the magnetic domain control layer 13b. The deposition conditions for forming the upper soft magnetic layer 13c are the same as those for forming the lower soft magnetic layer 13a. The upper soft magnetic layer 13c can be likewise made of an amorphous material obtained by adding to an iron-cobalt (Fe—Co) alloy which is composed to form a body-centered cubic (bcc) structure, at least one of the following elements: zirconium (Zr); tantalum (Ta); niobium (Nb); silicon (Si); boron (B); titanium (Ti); tungsten (W); chromium (Cr) and carbon (C). Preferably, the thickness of the upper soft magnetic layer 13c lies between 20 and 30 nm inclusive.

The soft magnetic under layer 13 having a laminated structure formed of the lower soft magnetic layer 13a, the magnetic domain control layer 13b and the upper soft magnetic layer 13c is formed over the seed layer 12 in the manner as above described. In the soft magnetic under layer 13 of this laminated structure, antiferromagnetic coupling occurs between the lower and upper soft magnetic layers 13a and 13c with the magnetic domain control layer 13b in between, so that the respective magnetizations M₁ of the soft magnetic layers 13a and 13c stabilize in an antiparallel state. Even at the occurrence of the so-called “abutments (or magnetic domain walls)” in which magnetizations opposite in direction are present adjacent to each other within the lower or upper soft magnetic layer 13a or 13c, magnetic flux leaking from the magnetic domain walls circulate in the soft magnetic under layer 13 because the magnetizations of the soft magnetic layers 13a and 13c are in an anti-parallel state. Consequently, this structure reduces the likelihood that the magnetic flux originating from the magnetic domain walls will leak upwards out of the soft magnetic under layer 13, thus suppressing spike noise resulting from the detection of the magnetic flux by a magnetic head.

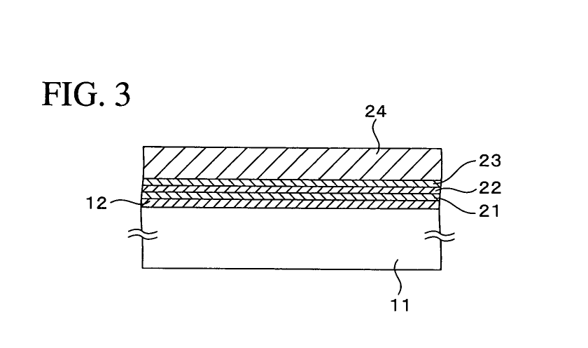

The structures adapted to suppress the spike noise include a structure in which a single soft magnetic soft magnetic under layer is formed above an antiferromagnetic layer. In the case of this structure, the antiferromagnetic layer is made of iridium-manganese (IrMn), iron-manganese (FeMn), or the like. As shown for example in FIG. 3, the structure may be formed of a nickel-iron (NiFe) layer 21, an IrMn layer (or an antiferromagnetic layer) 22 and an NiFe layer 23, which are formed over the seed layer 12, and a soft magnetic soft magnetic under layer 24 formed over the NiFe layer 23 and made of a soft magnetic material amorphized by adding zirconium (Zr) or tantalum (Ta) to an iron-cobalt (Fe—Co) alloy which is composed to form a bcc structure.

Then, as shown in FIG. 2C, the orientation control layer 14a is formed by forming a soft magnetic NiFeCr layer in a thickness of about 5 nm over the upper soft magnetic layer 13c by sputtering method under the following conditions: a deposition pressure of 0.3 to 0.8 Pa and a growth rate of 2 nm/sec.

In the first embodiment, the orientation control layer (or the NiFeCr layer) 14a is deposited over the upper soft magnetic layer 13c made of the Fe—Co alloy based amorphous material, so that the orientation control layer 14a has a crystal structure of an excellent face-centered cubic (fcc) structure. The orientation control layer 14a of this fcc structure may be made of platinum (Pt), palladium (Pd), NiFe, NiFeSi, aluminum (Al), copper (Cu) or indium (In), besides NiFeCr mentioned above.

When the orientation control layer 14a is made of a soft magnetic material such as NiFe, the orientation control layer 14a functions as part of the upper soft magnetic layer 13c, thus achieving an apparently short distance from the magnetic head to the soft magnetic under layer 13 and hence the effect of improving the sensitivity of the magnetic head.

Then, as shown in FIG. 2D, the nonmagnetic layer 14b is formed over the orientation control layer 14a by depositing ruthenium (Ru) in a thickness of about 10 nm by sputtering method under a deposition pressure of 4 to 10 Pa. At this time, preferably, the growth rate of the nonmagnetic layer 14b should be low. In the first embodiment, the growth rate of the nonmagnetic layer 14b is set at 0.5 nm/sec. The interlayer 14 formed of the orientation control layer 14a and the nonmagnetic layer 14b is formed in the manner as above described.

The crystal structure of the ruthenium (Ru) that forms the nonmagnetic layer 14b is a hexagonal close-packed (hcp) structure. An excellent crystallinity of the nonmagnetic layer 14b, results from a good lattice match between the hcp structure and the fcc structure which is the crystal structure of the orientation control layer 14a. By the action of the orientation control layer 14a as mentioned above, the crystal orientations of the nonmagnetic layer 14b are aligned in the same direction, so that the nonmagnetic layer 14b is excellent in crystallinity.

It should be noted that the nonmagnetic layer 14b of the hcp structure may also be made of a ruthenium (Ru) alloy containing cobalt (Co), chromium (Cr), tungsten (W) or rhenium (Re).

Then, as shown in FIG. 2E, the main recording layer 16 of the granular structure is formed over the nonmagnetic layer 14b. Description will now be given specifically with regard to the formation of the main recording layer 16. The base material 11 having the nonmagnetic layer 14b formed thereon is placed in a chamber of a sputtering apparatus, and a target made of a cobalt-chromium-platinum (Co—Cr—Pt) alloy having a Co content of 66 at %, a Cr content of 14 at % and a Pt content of 20 at % and a target made of silicon oxide (SiO₂) are loaded into the chamber. Hereinafter, an expression such as “CO₆₆Cr₁₄Pt₂₀” will be employed to give the respective contents of elements. Then, a sputtering gas having an argon gas (Ar) as a main ingredient and a trace of oxygen gas (O₂) (e.g., 0.2% to 2% in terms of the flow rate) added to the argon gas is introduced into the chamber, where a pressure is stabilized at a relatively high pressure (e.g., about 3 to 7 Pa) and a substrate temperature is kept at a relatively low temperature (e.g., 10 to 80 degrees centigrade).

Under this condition, sputtering is then started through the application of 400 to 1000 watts of radio frequency (RF) power between the targets and the base material 11. The frequency of the RF power for the sputtering is not particularly limited and can be set at, for example, 13.56 MHz. About 400 to 1000 watts of direct current (DC) power, instead of the RF power, may also be used for the sputtering.

When the deposition conditions for sputtering method are a relatively high pressure (e.g., about 3 to 7 Pa) and a relatively low temperature (e.g., about 10 to 80 degrees centigrade) as mentioned above, a sparse film results as compared to a film deposited at a low pressure and a high temperature. Thus, target materials Co—Cr—Pt alloy and SiO₂ do not mix with each other on the nonmagnetic layer 14b, thereby yielding the main recording layer 16 having the granular structure in which the magnetic particles 16b made of CoCrPt (CO₆₆Cr₁₄Pt₂₀) are dispersed in the nonmagnetic material 16a made of SiO₂ (see FIG. 1).

Preferably, the percentage of the content of the nonmagnetic material 16a in the main recording layer 16 lies between about 5 and 15 at % inclusive. In the first embodiment, the percentage of content of the nonmagnetic material 16a in the main recording layer 16 is set at 7 at %. The thickness of the main recording layer 16 is not particularly limited. In the first embodiment, the thickness of the main recording layer 16 is 12 nm. The growth rate of the main recording layer 16 under formation is set at, for example, 5 nm/sec.

The nonmagnetic layer 14b of the hcp structure underneath the main recording layer 16 functions to orient the magnetic particles 16b perpendicularly to the film surface. Thereby, the magnetic particles 16b take on the crystal structure of the hcp structure extending perpendicularly as in the case of the nonmagnetic layer 14b, and moreover, the direction of the height of a hexagonal prism of the hcp structure coincides with the easy magnetization axis, so that the main recording layer 16 exhibits perpendicular magnetic anisotropy.

In the main recording layer 16 of the granular structure as mentioned above, each of the magnetic particles 16b is isolated from one another with its axis of easy magnetization oriented perpendicularly, thus achieving a reduction in noise resulting from the main recording layer 16.

In addition, when the percentage of the Pt content in the magnetic particles 16b is equal to or more than 25 at %, a magnetic anisotropy constant Ku of the main recording layer 16 decreases. Preferably, the percentage of the Pt content in the magnetic particles 16b is, therefore, less than 25 at %. As mentioned above, a trace of O₂ gas, e.g., about 0.2 to 2% of O₂ gas in terms of the flow rate can be mixed into the sputtering gas to thereby promote the isolation between the magnetic particles 16b in the main recording layer 16 and hence improve the characteristics of electromagnetic conversion.

The surface of the nonmagnetic layer 14b to underlie the main recording layer 16 can be made more uneven to promote the isolation between the magnetic particles 16b, that is, enlargement of spaced intervals between the magnetic particles 16b. The Ru layer to form the nonmagnetic layer 14b can be grown at a low growth rate of the order of 0.5 nm/sec to thus make the surface more uneven.

Although the description has been given with reference to the first embodiment with regard to a case where the nonmagnetic material 16a is made of silicon oxide, other oxides may be used for the nonmagnetic material 16a. Such oxides include oxides of, for example, titanium (Ti), chromium (Cr) and zirconium (Zr). Further, any one of nitrides of silicon (Si), titanium (Ti), chromium (Cr) and zirconium (Zr) may be used for the nonmagnetic material 16a.

Particles made of a cobalt-iron (Co—Fe) alloy may be employed as the magnetic particles 16b. When the Co—Fe alloy is used, it is preferable that the main recording layer 16 be subjected to heat treatment so that the magnetic particles 16b take on the crystal structure of a honeycomb chained triangle (HCT) structure. Copper (Cu) or silver (Ag) may be added to this Co—Fe alloy.

Then, the auxiliary write layer 17 is formed by depositing an alloy having cobalt (Co) and chromium (Cr) as main ingredients (e.g., CO₆₇Cr₁₉Pt₁₀B₄) in a thickness of about 6 nm over the main recording layer 16 by sputtering method using an argon gas (Ar) as a sputtering gas. The deposition conditions for the auxiliary write layer 17 are not particularly limited. In the first embodiment, the deposition conditions are a deposition pressure of 0.3 to 0.8 Pa and a growth rate of 5 nm/sec.

Crystals of CoCrPtB (e.g., CO₆₇Cr₁₉Pt₁₀B₄) which forms the auxiliary write layer 17 take on the same hcp structure as those of the magnetic particles 16b in the main recording layer 16 underneath the auxiliary write layer 17. Thus, an excellent lattice match exists between the magnetic particles 16b and the auxiliary write layer 17, so that the auxiliary write layer 17 having excellent crystallinity is grown over the main recording layer 16.

Then, as shown in FIG. 2F, the protective layer 18 is formed over the recording layer 15 by depositing a DLC (diamond like carbon) layer in a thickness of about 4 nm by RF-CVD (radio frequency-chemical vapor deposition) method using a C₂H₂ gas as a reactant gas. The deposition conditions for the protective layer 18 are, for example, a deposition pressure of about 4 Pa, 1000 watts of RF power, and a bias voltage of 200 V between the base material and the shower head.

The magnetic recording medium 10 according to the first embodiment is brought to completion in the manner as above described.

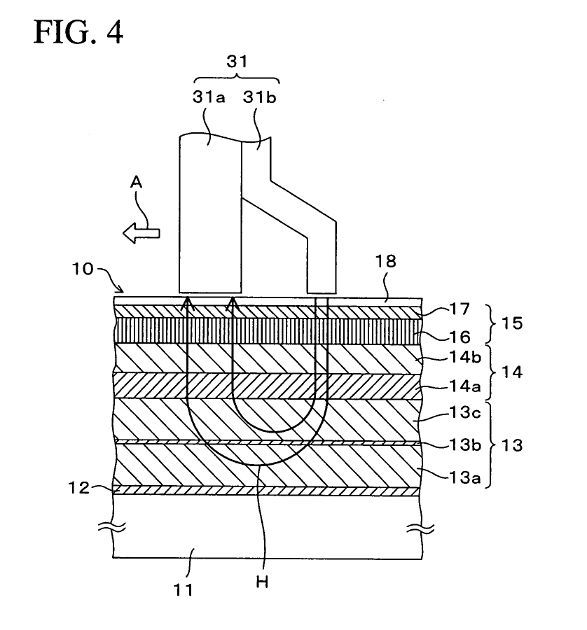

FIG. 4 is a schematic sectional view of assistance in explaining the operation for writing information to the magnetic recording medium 10 according to the first embodiment.

To write information to the magnetic recording medium 10, as shown in FIG. 4, a magnetic head (or a write head) 31 including a main magnetic pole 31b and a return yoke 31a is faced at its end with the magnetic recording medium 10, and then the magnetic head 31 receives feed of a signal according to information to be recorded. Upon receipt of the signal, the main magnetic pole 31b having a small cross section produces a recording magnetic field H, which then passes perpendicularly through the recording layer 15 to go toward the soft magnetic under layer 13. When passing through the recording layer 15, the recording magnetic field H effects perpendicular magnetization of a magnetic domain of the recording layer 15, which is present directly under the main magnetic pole 31b.

After passing perpendicularly through the recording layer 15, the recording magnetic field H travels in the soft magnetic under layer 13 in the in-plane direction thereof, then again passes perpendicularly through the recording layer 15, and then returns to the return yoke 31a having a large cross section. At this point, the direction of magnetization of the recording layer 15 does not change because of a low magnetic flux density.

By changing the direction of the recording magnetic field H according to information to be recorded, while moving the magnetic recording medium 10 relatively to the magnetic head 31 in the direction indicated by the arrow A of FIG. 4, plural magnetic domains are perpendicularly magnetized and formed in series along tracks of the magnetic recording medium 10, so that a series of information items are recorded on the magnetic recording medium 10.

As previously mentioned, in the first embodiment, the soft magnetic layers 13a and 13c that form the soft magnetic under layer 13 are each made of the material amorphized by adding an element such as Zr or Ta to the Fe—Co alloy which is composed to form the bcc structure. Description will be given below with regard to the results of examinations as to the relation between the materials for the soft magnetic layers 13a and 13c and the coercivity of the recording layer.

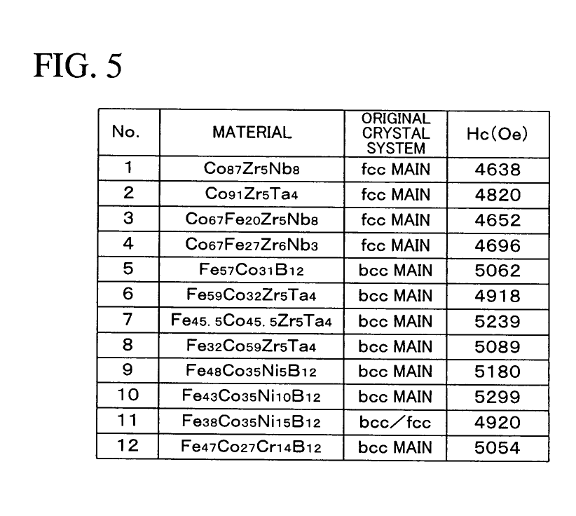

Materials, which are assigned Nos. 1 to 12, respectively, as shown in FIG. 5, were used to form soft magnetic layers. As employed in FIG. 5, the term “original crystal system” refers to the crystal system of metal except for elements for inducing amorphization. As for the material No. 1, namely, a Co—Zr—Nb (cobalt-zirconium-niobium) alloy (CO₈₇Zr₅Nb₈), the crystal system of Co alone, exclusive of Zr and Nb added for amorphization, is given in FIG. 5. As for the material Nos. 6 to 8, namely, Fe—Co—Zr—Ta (iron-cobalt-zirconium-tantalum) alloys, the crystal system of the Fe—Co alloy, exclusive of Zr and Ta added for amorphization, is given in FIG. 5. The crystal systems of these alloys are determined by percentage compositions of elements that form the alloys. Incidentally, the phrase “constructed mainly of fcc” is employed in FIG. 5 because the materials each have the fcc structure in general configuration but can possibly have, in part, a different structure. Likewise, the phrase “constructed mainly of bcc” is employed in FIG. 5 because the materials each have the bcc structure in general configuration but can possibly have, in part, a different structure.

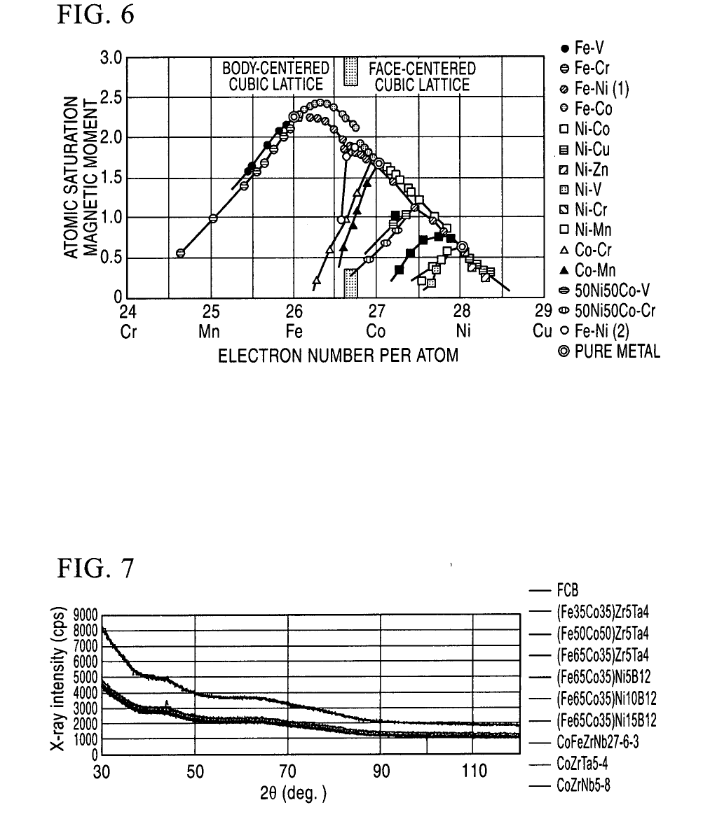

FIG. 6 is a plot showing a Slater-Pauling curve. From FIG. 6, it can be seen that the Fe—Co alloy, for example, takes on the bcc structure when the Fe content is equal to or more than 30 at %. It can also be seen that Cr, Mn or Fe alone takes on the bcc structure and Co, Ni or Cu alone takes on the fcc structure. The crystal structure of the alloy is determined by the percentage composition of these elements.

Magnetic recording media (or test specimens) including soft magnetic under layers made of the alloys of compositions, which are assigned Nos. 1 to 12, respectively, as shown in FIG. 5, were manufactured, and the coercivity (Hc) values of main recording layers of the magnetic recording media were measured. The measured values also are given in FIG. 5. Incidentally, a magnetization loop tracer utilizing a Kerr effect was used to measure the coercivity. The auxiliary write layers were omitted from the test specimens for use in coercivity measurements.

As can be seen from FIG. 5, the Fe—Co alloys (Nos. 5 to 12) each having the original crystal system of the bcc structure have high coercivity (Hc). When any of the alloys assigned Nos. 6 to 8 in particular, each of which contains the Fe—Co alloy having the original crystal system of the bcc structure and Zr and Ta added to the Fe—Co alloy, is used, the coercivity is equal to or higher than 5000 Oe. It can be therefore seen that these alloys (Nos. 6 to 8) are effective in increasing a recording density and improving the reliability of the writing and reading of information.

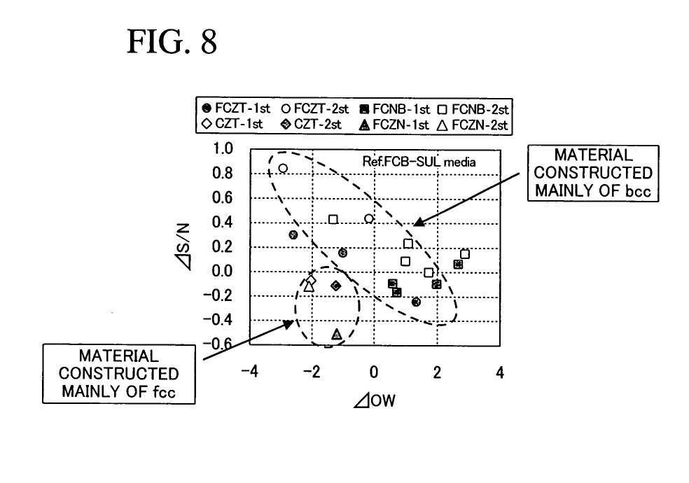

Next, XRD (X-ray diffraction) measurements were made on the soft magnetic under layers. The results of the measurements are given in FIG. 7. From FIG. 7, it can be seen that no clear diffraction ray is observed on any of the test specimens and the soft magnetic under layers of all the test specimens are amorphized. For each of the test specimens used in the XRD measurements, the soft magnetic under layer alone was formed in a thickness of 50 nm over a glass substrate in the manner as previously mentioned.

Next, examinations were made as to the read/write (R/W) characteristics of the magnetic recording media using the soft magnetic under layers. Although test specimens for use in the examinations are basically the same as the test specimens for use in the coercivity measurements, the materials for the soft magnetic under layers and the thicknesses of the recording layers used in the former vary somewhat from those used in the latter.

FIG. 8 shows the results of the examinations as to the read/write characteristics of the test specimens. In FIG. 8, the horizontal axis represents OW (overwrite) characteristics which are used as an index of ease of writing of information, and the vertical axis represents S/N (signal-to-noise ratio) characteristics which are used as an index of signal quality. It may be said that the writing of information becomes easier as the value of the OW characteristics becomes smaller (that is, the value becomes negatively larger). It may be also said that the signal quality improves as the value of the S/N characteristics becomes larger. A write current for measurements of the OW characteristics is set at 35 mA. The conventional magnetic recording medium in which the Fe—Co—B alloy is used for the soft magnetic under layer is used as the reference.

As can be seen from FIG. 8, the test specimens using the alloys having the fcc-based original crystal systems, in general, have low S/N ratios, and the test specimens using the alloys having the bcc-based original crystal systems tend to have high S/N ratios. The test specimens (marked with a circle (“0”) in FIG. 8) using the Fe—Co—Zr—Ta alloys, in particular, are excellent in both the OW characteristics and the S/N characteristics.

### (2) Second Embodiment

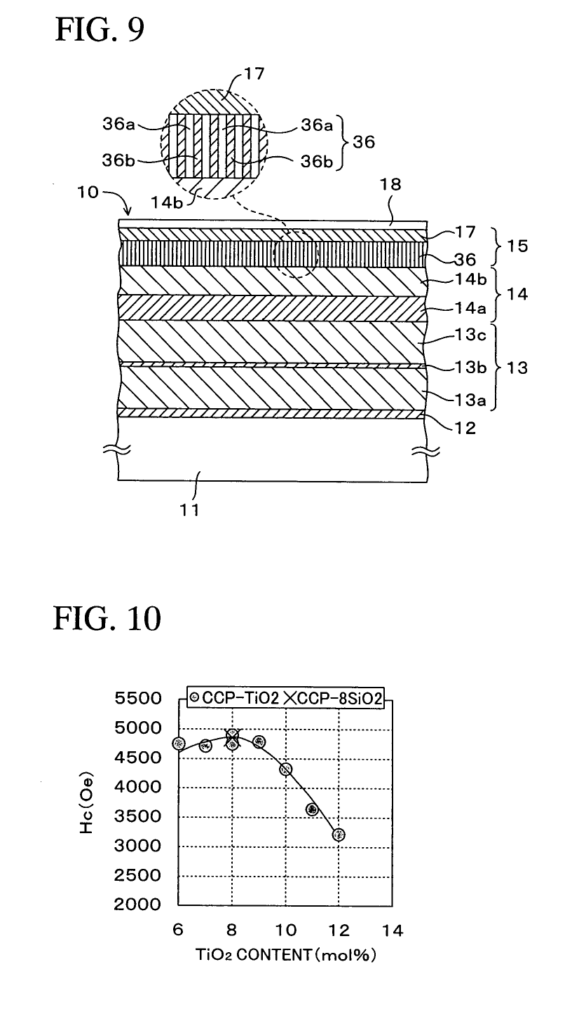

FIG. 9 is a cross-sectional view showing a magnetic recording medium according to a second embodiment of the present invention. The second embodiment is different from the first embodiment in the configuration of the main recording layer (or the first recording layer). Since the configurations of other structural components of the second embodiment are basically the same as those of the first embodiment, the same parts shown in FIG. 1 are designated by the same reference numerals in FIG. 9, and the detailed description of the same parts will be omitted.

In the second embodiment, a main recording layer 36 has a granular structure, which is formed of magnetic particles 36b made of a cobalt-chromium-platinum (Co—Cr—Pt) alloy, and a nonmagnetic material 36a made of titanium oxide (TiO₂), which provides magnetic isolation between the magnetic particles 36b. The Cr content in the magnetic particles 36b lies between 11 and 15 at % inclusive, and the Pt content therein lies between 11 and 21 at % inclusive. The molar ratio between the magnetic particles 36b (or the Co—Cr—Pt alloy) and the nonmagnetic material 36a (or TiO₂) lies between a ratio of 93 to 7 and a ratio of 91 to 9.

FIG. 10 is a plot showing the results of examinations as to the relation between the titanium oxide (TiO₂) content in the main recording layer 36 and the coercivity (Hc), in which the horizontal axis represents the TiO₂ content and the vertical axis represents the coercivity. Incidentally, the auxiliary write layers are omitted from test specimens for use in coercivity measurements. Also, the thicknesses of the layers are different from those of the layers of the test specimens of the first embodiment, which have undergone the coercivity measurements.

As can be seen from FIG. 10, the coercivity of the magnetic recording medium deteriorates when the titanium oxide content in the main recording layer is equal to or more than 10 mol %. The reason for this occurrence can possibly be that a titanium oxide content of 10 mol % or more inhibits epitaxial growth of the magnetic particles (or the Co—Cr—Pt alloy) and thus leads to deterioration in crystalline orientation and also to finer crystal grains.

Alternatively, a titanium oxide content of 6 mol % or less in the main recording layer leads to insufficient isolation between the crystal grains of the magnetic particles (or the Co—Cr—Pt alloy), thus resulting in deterioration in the coercivity. In the second embodiment, the titanium oxide (TiO₂) content in the main recording layer is therefore set at 7 to 9 mol %.

In FIG. 10, there is given the result of coercivity measurement (marked with an “X” in FIG. 10), which was made, under the same conditions, on the magnetic recording medium using silicon oxide (SiO₂) as the nonmagnetic material in the main recording layer. As can be seen from FIG. 10, the coercivity of the magnetic recording medium using titanium oxide as the nonmagnetic material is substantially equal to the coercivity of the magnetic recording medium using silicon oxide as the nonmagnetic material.

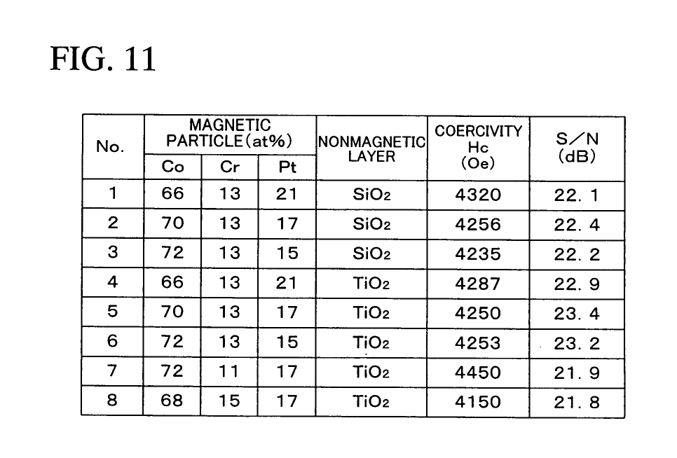

FIG. 11 is a table showing the results of measurements of the coercivity and the S/N ratio (or the signal-to-noise ratio), which were made on the magnetic recording media in situations where the magnetic particles 36b are made of varying compositions of Co, Cr and Pt and the nonmagnetic material is silicon oxide (SiO₂) or titanium oxide. Incidentally, the auxiliary write layers are omitted from test specimens for use in the coercivity and S/N ratio measurements. Also, the thicknesses of the layers are different from those of the layers of the test specimens of the first embodiment, which have undergone the coercivity measurements.

From FIG. 11, it can be seen that the use of titanium oxide (TiO₂) as the nonmagnetic material increases the S/N ratio as compared to the use of silicon oxide (SiO₂). However, when the Pt content in the magnetic particles is less than 11 at % or is more than 21 at %, an anisotropic magnetic field (Hk) becomes low, so that the magnetic properties of the magnetic recording medium deteriorate. In the second embodiment, the Pt content in the magnetic particles is therefore set to lie between 11 and 21 at % inclusive.

Furthermore, a Cr content of less than 11 at % in the magnetic particles increases saturation magnetization (Ms) and the anisotropic magnetic field (Hk), thus increases normalized noise, and thus reduces the S/N ratio. A Cr content of more than 15 at % in the magnetic particles deteriorates the magnetic properties and thus reduces the S/N ratio. In the second embodiment, the Cr content in the magnetic particles is therefore set to lie between 11 and 15 at % inclusive.

As described above, in the second embodiment, titanium oxide is used as the nonmagnetic material 36a in the main recording layer (or a granular layer) 36, and the Cr content and the Pt content in the magnetic particles 36b and the molar ratio between the magnetic particles 36b and the nonmagnetic material 36a are set within respective predetermined ranges. Thereby, the second embodiment can increase the S/N ratio and thus achieve the magnetic recording medium capable of still higher performance, as compared to the first embodiment.

(Magnetic Recording Device)

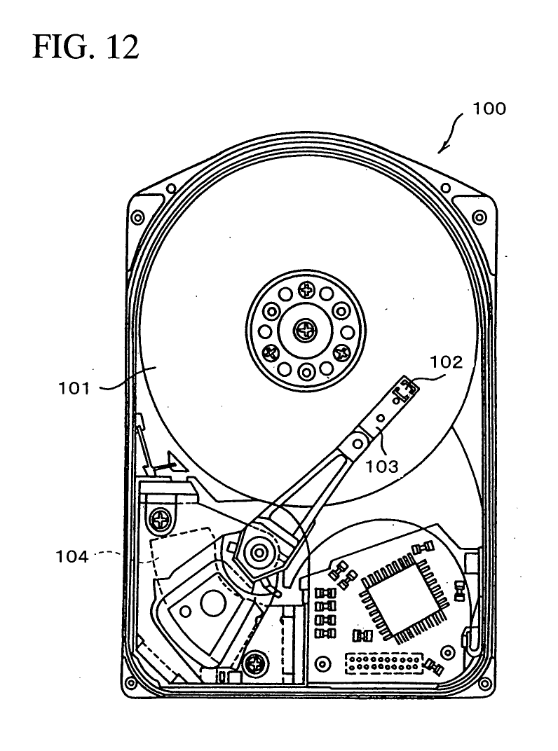

FIG. 12 is a plan view showing a magnetic recording device according to an embodiment of the present invention.

A magnetic recording device 100 includes a housing, a disc-shaped magnetic recording medium (or a magnetic disk) 101, a spindle motor (not shown) which rotates the magnetic recording medium 101, a magnetic head 102 which performs the writing and reading of data, a suspension 103 which supports the magnetic head 102, and an actuator 104 which drives and controls the suspension 103 radially of the magnetic recording medium 101, all of which are accommodated in the housing. The magnetic recording medium 101 has the construction described with reference to the above first or second embodiment.

When the magnetic recording medium 101 is rotated at high speed by the spindle motor, the magnetic head 102 is levitated slightly clear of the magnetic recording medium 101 by airflow produced by the rotation of the magnetic recording medium 101. The magnetic head 102 is moved by the actuator 104 radially of the magnetic recording medium 101, and the magnetic head 102 performs the writing or reading of information to or from the magnetic recording medium 101.

Since the magnetic recording device configured as mentioned above uses the magnetic recording medium 101 having the construction described with reference to the first or second embodiment, the magnetic recording device can record information at high densities and also has a high degree of reliability of the writing and reading of information.

What is claimed is:

1. A magnetic recording medium, comprising:
a nonmagnetic base material;
a soft magnetic under layer formed over the nonmagnetic base material;
an interlayer formed over the soft magnetic under layer; and
a recording layer formed over the interlayer and having perpendicular magnetic anisotropy,
wherein the soft magnetic under layer is made of a material amorphized by adding at least one kind of element of zirconium (Zr) and tantalum (Ta) to an iron-cobalt (Fe—Co) alloy which is composed to form a body-centered cubic structure.

2. A magnetic recording medium, comprising:
a nonmagnetic base material;
a soft magnetic under layer formed over the nonmagnetic base material;
an interlayer formed over the soft magnetic under layer; and
a recording layer formed over the interlayer and having perpendicular magnetic anisotropy,
wherein the soft magnetic under layer is made of a material amorphized by adding to an iron-cobalt (Fe—Co) alloy which is composed to form a body-centered cubic structure, at least one of the following elements: niobium (Nb); silicon (Si); boron (B); titanium (Ti); tungsten (W); chromium (Cr) and carbon (C).

3. The magnetic recording medium according to any one of claims 1 and 2, wherein the interlayer is formed of a polycrystalline film having a face-centered cubic structure, and a polycrystalline film formed over the polycrystalline film and having a hexagonal close-packed structure.

4. The magnetic recording medium according to any one of claims 1 and 2, wherein the recording layer has a granular structure.

5. The magnetic recording medium according to any one of claims 1 and 2, wherein the recording layer has a granular structure which is formed of magnetic particles made of a cobalt-chromium-platinum (Co—Cr—Pt) alloy and a nonmagnetic layer made of titanium oxide, the Cr content in the Co—Cr—Pt alloy lies between 11 and 15 at % inclusive, the Pt content in the Co—Cr—Pt alloy lies between 11 and 21 at % inclusive, and the molar ratio between the Co—Cr—Pt alloy and the titanium oxide lies between a ratio of 93 to 7 and a ratio of 91 to 9 inclusive.

6. The magnetic recording medium according to any one of claims 1 and 2, wherein the recording layer is formed of a first recording layer having a granular structure, and a second recording layer formed over the first recording layer and made of a Co based alloy.

7. The magnetic recording medium according to any one of claims 1 and 2, wherein the soft magnetic under layer is formed of a first soft magnetic layer made of the amorphized material, a nonmagnetic layer formed over the first soft magnetic layer, and a second soft magnetic layer made of the amorphized material and formed over the nonmagnetic layer.

8. The magnetic recording medium according to claim 7, wherein the thicknesses of the first and second soft magnetic layers each lie between 20 and 30 nm inclusive.

9. The magnetic recording medium according to claim 7, wherein the first soft magnetic layer is antiferromagnetically coupled to the second soft magnetic layer.

10. The magnetic recording medium according to any one of claims 1 and 2, wherein the Fe content in the amorphized material is equal to or more than 30 at %.

11. A magnetic recording device, comprising:
a magnetic recording medium capable of magnetically recording information;
a magnetic head which performs the writing and reading of information to and from the magnetic recording medium; and
moving means for moving the magnetic recording medium relatively to the magnetic head,
wherein the magnetic recording medium includes:
a nonmagnetic base material;
a soft magnetic under layer formed over the nonmagnetic base material;
an interlayer formed over the soft magnetic under layer; and
a recording layer formed over the interlayer and having perpendicular magnetic anisotropy, and
wherein the soft magnetic under layer is made of a material amorphized by adding at least one kind of element of zirconium (Zr) and tantalum (Ta) to an iron-cobalt (Fe—Co) alloy which is composed to form a body-centered cubic structure.

12. A magnetic recording device, comprising:
a magnetic recording medium capable of magnetically recording information;
a magnetic head which performs the writing and reading of information to and from the magnetic recording medium; and
moving means for moving the magnetic recording medium relatively to the magnetic head,
wherein the magnetic recording medium includes:
a nonmagnetic base material;
a soft magnetic under layer formed over the nonmagnetic base material;
an interlayer formed over the soft magnetic under layer; and
a recording layer formed over the interlayer and having perpendicular magnetic anisotropy, and
wherein the soft magnetic under layer is made of a material amorphized by adding to an iron-cobalt (Fe—Co) alloy which is composed to form a body-centered cubic structure, at least one of the following elements: niobium (Nb); silicon (Si); boron (B); titanium (Ti); tungsten (W); chromium (Cr) and carbon (C).

13. The magnetic recording device according to any one of claims 11 and 12, wherein the interlayer is formed of a polycrystalline film having a face-centered cubic structure, and a polycrystalline film formed over the polycrystalline film and having a hexagonal close-packed structure.

14. The magnetic recording device according to any one of claims 11 and 12, wherein the recording layer has a granular structure.

15. The magnetic recording device according to any one of claims 11 and 12, wherein the recording layer has a granular structure which is formed of magnetic particles made of a cobalt-chromium-platinum (Co—Cr—Pt) alloy and a nonmagnetic layer made of titanium oxide, the Cr content in the Co—Cr—Pt alloy lies between 11 and 15 at % inclusive, the Pt content in the Co—Cr—Pt alloy lies between 15 and 21 at % inclusive, and the molar ratio between the Co—Cr—Pt alloy and the titanium oxide lies between a ratio of 93 to 7 and a ratio of 91 to 9 inclusive.

16. The magnetic recording device according to any one of claims 11 and 12, wherein the recording layer is formed of a first recording layer having a granular structure, and a second recording layer formed over the first recording layer and made of a Co based alloy.

17. The magnetic recording device according to any one of claims 11 and 12, wherein the soft magnetic under layer is formed of a first soft magnetic layer made of the amorphized material, a nonmagnetic layer formed over the first soft magnetic layer, and a second soft magnetic layer made of the amorphized material and formed over the nonmagnetic layer.

18. The magnetic recording device according to claim 17, wherein the thicknesses of the first and second soft magnetic layers each lie between 20 and 30 nm inclusive.

19. The magnetic recording device according to claim 17, wherein the first soft magnetic layer is antiferromagnetically coupled to the second soft magnetic layer.

20. The magnetic recording device according to any one of claims 11 and 12, wherein the Fe content in the amorphized material is equal to or more than 30 at %.
